(19) United States
(12) Patent Application Publication
(10) Pub. No.: US 2010/0077932 A1
(43) Pub. Date: Apr. 1, 2010

(54) SOLVENT REMOVAL ASSISTED MATERIAL TRANSFER FOR FLEXOGRAPHIC PRINTING

(75) Inventors: Mikhail L. Pekurovsky, Bloomington, MN (US); Ryan T. Woldt, Minnepolis, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, St. Paul, MN (US)

(21) Appl. No.: 12/514,895

(22) PCT Filed: Nov. 5, 2007
(86) PCT No.: PCT/US2007/083563

§ 371 Date: May 14, 2009

Related U.S. Application Data
(60) Provisional application No. 60/865,976, filed on Nov. 15, 2006.

(51) Int. Cl. B41M 1/04; B41F 5/24

(52) U.S. Cl. 101/141; 101/487

(57) ABSTRACT

Methods and systems for flexographic printing are discussed. The methods include removing solvent from a material to be transferred from a donor substrate to a feature of a flexographic printing plate. Solvent is removed from the material prior to transfer to the feature, resulting in improved transfer of the material to the feature. The systems include solvent removal apparatuses for facilitating removal of solvent from the material.

### FIELD

This disclosure relates to printing; particularly to flexographic printing; and more particularly to high resolution flexographic printing.

### BACKGROUND

Delivery of inks to flexographic printing plates is an important part of a flexographic printing technology. Typically, ink delivery uses anilox rolls that have an exposed surface built out of small cells. These cells are filled with ink by dipping the roll into a pan filled with ink and then doctoring off excess ink with a blade. Ink from cells of the anilox roll is transferred to raised features of a flexographic printing plate. The smallest cell size of an anilox roll currently available is about 20 micrometers for 1200 line screen anilox rolls or about 15 micrometers for 1600 dpi rolls. Significant challenges are present when inking flexographic features having lateral dimensions smaller than 20 micrometers. For example, as the difference in size between the anilox roll cell and the feature increases, the variability in the amount of ink that the feature picks up also would likely increase. At least in part, this variability can be attributed to the relative position of the feature and the cell. As such, the ability to achieve finer resolution printing with flexographic systems has been hindered.

### BRIEF SUMMARY

The disclosure presented herein describes methods and systems for improved transfer of material from a donor substrate to a feature of a flexographic printing plate.

In an embodiment, a method for flexographic printing is described. The method comprises removing at least a portion of a solvent from a material to achieve a reduced-solvent material. The material may be disposed onto a donor substrate, e.g. by die coating, and the solvent removed while the material is on the donor substrate. The method further comprises disposing the reduced-solvent material onto a feature of a flexographic printing plate. The reduced-solvent material may be disposed onto the feature by transferring reduced-solvent material from the donor substrate to the feature. Any amount of solvent removal is expected to result in more uniform amounts of reduced-solvent material being disposed on the feature of the flexographic printing plate. In some cases removing at least 10% of the solvent may be appropriate. In other cases, removing at least 50%, 90%, 95%, 99%, or substantially all of the solvent may be desired. The method further comprises transferring the reduced-solvent material from the feature of the flexographic printing plate to a recipient substrate. The reduced-solvent substrate may then be cured on the recipient substrate. The method is useful for features of any size. However, the advantages of the method may be more recognized when using features having a lateral dimension of 15 micrometers or less; e.g., 10 micrometers or less, or 5 micrometers or less.

In an embodiment, a method for flexographic printing is described. The method comprises disposing onto a donor substrate a material comprising a solvent; removing at least a portion of the solvent from the material on the donor substrate to achieve a reduced-solvent material; transferring the reduced-solvent material from the donor substrate to a feature of a flexographic printing plate; and transferring the reduced-solvent material from the feature to a recipient substrate. The method further comprises
reducing an imprint on the donor substrate that results from transfer of the reduced-solvent material from the donor substrate to the feature of the flexographic printing plate. The imprints may be reduced or removed by removing untransferred reduced-solvent material from the donor substrate to achieve a donor substrate suitable for receiving the material. The material may then be disposed onto the donor substrate suitable for receiving the material, and the process repeated.

In an embodiment, a flexographic printing system is described. The system comprises a donor substrate configured to receive a material such that the material is disposed onto the donor substrate. The donor substrate may be in the form of a surface of an inking roll, which surface is smooth or substantially smooth. The material comprises a solvent. The system further comprises a solvent removal apparatus capable of removing the solvent from the material disposed onto the donor substrate to produce a reduced-solvent material disposed onto the donor substrate. The system also comprises a flexographic roll configured to attachably receive a flexographic printing plate comprising a feature. The flexographic roll is moveable relative to the donor substrate to allow the reduced-solvent material on the donor substrate to be transferred to the feature of the printing plate. The system further comprises a backup roll positioned relative to the flexographic roll such that movement of the backup roll relative to the flexographic roll is capable of causing a recipient substrate to move between the backup roll and the flexographic roll to allow the reduced-solvent substrate to be transferred from the feature to the recipient substrate. The system may further comprise an imprint reducing apparatus for reducing imprints on the donor substrate that result from transfer of the reduced-solvent material from the donor substrate to the feature of the plate. The system is useful for flexographic printing plates having features of any size. However, the advantages of the system may be more recognized when using plates having features with a lateral dimension of 15 micrometers or less; e.g., 10 micrometers or less or 5 micrometers or less.

Removing solvent from a material on a donor substrate prior to transfer to a feature of a flexographic printing plate provides several advantages. For example, removing solvent from a material to be transferred from a donor substrate to a recipient substrate by a feature of a flexographic printing plate should result in improved consistency of transfer of material from the donor substrate to the feature, particularly where the feature has a small lateral dimension. In addition, the use of a solvent-based material facilitates deposition of the material on the donor substrate, which can add to the uniformity of the amount of material transferred from the donor substrate to the feature. By reducing solvent in the material, the properties of the material, e.g. viscosity, thickness, adhesion, tack, etc., may be changed from properties desirable for disposing on a donor substrate to properties more desirable for disposing on a feature of a flexographic printing plate. These and other advantages of the systems and methods described herein are now evident or will become evident upon reading the description that follows.

### BRIEF DESCRIPTION OF THE DRAWINGS

FIG. 1-3 are a flow diagrams illustrating methods for flexographic printing.

FIGS. 4A and B are a side views of diagrammatic representations of flexographic printing systems.

FIGS. 5 and 6 are side views of diagrammatic representations of some components of flexographic printing systems.

FIGS. 7-9 are side views of diagrammatic representations of flexographic printing systems.

FIG. 10 is a micrograph image of hardcoat printed on poly(ethylene terephtalate) using an exemplary system and method.

FIG. 11 is a micrograph image of an illustrative flexographic printing plate surface.

FIG. 12 is a micrograph image of hardcoat printed on poly(ethylene terephtalate) using an exemplary system and method.

The figures are not necessarily to scale. Like numbers used in the figures refer to like components, steps and the like. However, it will be understood that the use of a number to refer to a component in a given figure is not intended to limit the component in another figure labeled with the same number.

### DETAILED DESCRIPTION

In the following description, reference is made to the accompanying drawings that form a part hereof, and in which are shown by way of illustration several specific embodiments. It is to be understood that other embodiments are contemplated and may be made without departing from the scope or spirit of the present invention. The following detailed description, therefore, is not to be taken in a limiting sense.

### Overview

For the methods and systems described herein, removal of a solvent from a material to form a reduced-solvent material prior to transfer to a feature of a flexographic printing plate results in improved transfer of material to the feature, relative to transfer of similar material in which solvent has not been removed. While this is the case for flexographic printing plates having features of any size, the benefits of transfer of reduced-solvent material will be more evident with features having smaller lateral dimensions. In part this is because existing flexographic printing systems are quite good at transferring uniform amounts of material from a donor substrate, such as an anilox roll, to a feature of a flexographic printing plate, where the flexographic printing plate has a lateral dimension greater than about 20 micrometers. However, as the lateral dimensions of the feature decreases much beyond the current limitations of the size of the cells of an anilox roll; i.e., less than about 15 micrometers, the uniformity of transfer of a material comprising a high concentration of solvent decreases. A countervailing concern is that it becomes more difficult to dispose material on a donor substrate as the concentration of solvent is reduced. The present disclosure describes methods and systems that account for these opposing difficulties by removal of solvent from a material prior to transferring a material from a donor substrate to a feature of a flexographic printing plate.

The methods and systems described herein may be used with flexographic printing plates having features of any size. However, the advantages of the methods and systems may be more recognized when using features having lateral dimensions of 15 micrometers or less; e.g., 10 micrometers or less, or 5 micrometers or less. Flexographic plates having features with lateral dimensions of 15 micrometers or less may be as described in, e.g., U.S. Provisional Patent Application Ser. No. 60/865,979, Attorney Docket No. 62622US002, entitled “SOLVENT-ASSISTED EMBOSSING OF FLEXOGRAPHIC PRINTING PLATES” to Mikhail Pekurovsky et al., filed on even date herewith, which application is incorporated herein by reference in its entirety to the extent it does not contradict the disclosure presented herein.

### Definitions

All scientific and technical terms used herein have meanings commonly used in the art unless otherwise specified. The definitions provided herein are to facilitate understanding of certain terms used frequently herein and are not meant to limit the scope of the present disclosure.

As used herein, “flexographic printing” means a rotary printing process using a flexible printing plate; i.e., a flexographic printing plate. Any material that may be transferred from a flexographic printing plate to a recipient substrate may be “printed”.

As used herein, a “material” to be printed means a composition that is capable of being transferred from a feature of a flexographic printing plate to a recipient substrate. A material may comprise a solvent, and the components of the material may be dissolved, dispersed, suspended, or the like in the solvent.

As used herein, “reduced-solvent material” means a material from which at least a portion of a solvent has been removed. The solvent may be removed actively or passively.

As used herein, “flexographic printing plate” refers to a printing plate having features onto which material to be transferred to a recipient substrate may be disposed, wherein the plate or the features are capable of deforming when contacting the recipient substrate (relative to when not contacting the recipient substrate). A flexographic printing plate may be a flat plate that can be attached to a roll; e.g., by mounting tape, or a sleeve attached to a chuck, such as with Dupont™ CYREL® round plates.

As used herein, “feature” means a raised projection of a flexographic printing plate. The raised projection has a distal surface (or land), removed from the bulk of the flexographic printing plate, on which material may be disposed.

As used herein, “donor substrate” means a substrate onto which a material transferable to a feature of a flexographic printing plate may be disposed. Donor substrates may be in any form suitable for the transfer of material to a feature. For example, donor substrates may be films, plates or rolls.

As used herein, “recipient substrate” means a substrate onto which a material may be printed. Exemplary substrates include but are not limited to inorganic substrates such as quartz, glass, silica and other oxides or ceramics such as alumina, indium tin oxide, lithium tantalate (LiTaO.sub.3), lithium niobate (LiNbO.sub.3), gallium arsenide (GaAs), silicon carbide (SiC), langasite (LGS), zinc oxide (ZnO), aluminum nitride (AIN), silicon (Si), silicon nitride (Si.sub.3N.sub.4), and lead zirconium titanate (“PZT”); metals or alloys such as aluminum, copper, gold, silver and steel; thermoplastics such as polyesters (e.g., polyethylene terephthalate or polyethylene naphthalates), polyacrylates (e.g., polymethyl methacrylate or “PMMA”), poly(vinyl acetate) (“PVAC”), poly(vinylbutyral) (“PVB)”, poly(ethyl acrylate) (“PEA”), poly(diphenoxyphosphazene) (“PDPP”), polycarbonate (“PC”), polypropylene (“PP”), high density polyethylene (“HDPE”), low density polyethylene (“LDPE”), polysulfone (“PS”), polyether sulfone (“PES”), polyurethane (“PUR”), polyamide (“PA”), polyvinyl chloride (“PVC”), polyvinylidene fluoride (“PVdF”), polystyrene and polyethylene sulfide; and thermoset plastics such as cellulose derivatives, polyimide, polyimide benzoxazole and polybenzoxazole. Recipient substrates can also include paper, nonwovens and foams. Preferably care is taken when selecting the substrate so that there will be an adequate degree of adhesion between the substrate and the material.

As used herein, “curing” means a process of hardening of a material. Typically, curing refers to increasing cross-linking within the material. A “cured” material may be partially cured or fully cured. Materials capable of being cured may include an initiator for curing, such as photo initiators or thermal initiators.

As used herein, “comprising” and “including” are used in an open-ended fashion, and thus should be interpreted to mean “including, but not limited to . . . ”.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

### Materials to be Printed

Any material capable of being transferred to and from a feature of a flexographic printing plate may be used in accordance with the teachings presented herein. For example the material may comprise a curable resin.

Illustrative examples of resins that are capable of being polymerized by a free radical mechanism that can be used herein include acrylic-based resins derived from epoxies, polyesters, polyethers, and urethanes, ethylenically unsaturated compounds, aminoplast derivatives having at least one pendant acrylate group, isocyanate derivatives having at least one pendant acrylate group, epoxy resins other than acrylated epoxies, and mixtures and combinations thereof. The term acrylate is used here to encompass both acrylates and methacrylates. U.S. Pat. No. 4,576,850 (Martens) discloses examples of crosslinkable resins that may be used in cube corner element arrays and may be useful as the materials described herein.

Ethylenically unsaturated resins include both monomeric and polymeric compounds that contain atoms of carbon, hydrogen and oxygen, and optionally nitrogen, sulfur, and the halogens may be used herein. Oxygen or nitrogen atoms, or both, are generally present in ether, ester, urethane, amide, and urea groups. Ethylenically unsaturated compounds preferably have a molecular weight of less than about 4,000 and preferably are esters made from the reaction of compounds containing aliphatic monohydroxy groups, aliphatic polyhydroxy groups, and unsaturated carboxylic acids, such as acrylic acid, methacrylic acid, itaconic acid, crotonic acid, iso-crotonic acid, maleic acid, and the like. Such materials are typically readily available commercially and can be readily cross linked.

Some illustrative examples of compounds having an acrylic or methacrylic group that are suitable for use in accordance with the teachings presented herein are listed below:

### (1) Monofunctional Compounds:

ethylacrylate, n-butylacrylate, isobutylacrylate, 2-ethylhexylacrylate, n-hexylacrylate, n-octylacrylate, isooctyl acrylate, bornyl acrylate, tetrahydrofurfuryl acrylate, 2-phenoxyethyl acrylate, and N,N-dimethylacrylamide;

### (2) Difunctional Compounds:

1,4-butanediol diacrylate, 1,6-hexanediol diacrylate, neopentylglycol diacrylate, ethylene glycol diacrylate, triethyleneglycol diacrylate, tetraethylene glycol diacrylate, and diethylene glycol diacrylate; and

### (3) Polyfunctional Compounds:

trimethylolpropane triacrylate, glyceroltriacrylate, pentaerythritol triacrylate, pentaerythritol tetraacrylate, and tris(2-acryloyloxyethyl)isocyanurate. Some representative examples of other ethylenically unsaturated compounds and resins include styrene, divinylbenzene, vinyl toluene, N-vinyl formamide, N-vinyl pyrrolidone, N-vinyl caprolactam, monoallyl, polyallyl, and polymethallyl esters such as diallyl phthalate and diallyl adipate, and amides of carboxylic acids such as N,N-diallyladipamide.

Illustrative examples of photopolymerization initiators that can be blended with acrylic compounds in the present invention include the following: benzil, methyl o-benzoate, benzoin, benzoin ethyl ether, benzoin isopropyl ether, benzoin isobutyl ether, etc., benzophenone/tertiary amine, acetophenones such as 2,2-diethoxyacetophenone, benzyl methyl ketal, 1-hydroxycyclohexylphenyl ketone, 2-hydroxy-2-methyl-1-phenylpropan-1-one, 1-(4-isopropylphenyl)-2-hydroxy-2-methylpropan-1-one, 2-benzyl--2-N,N-dimethylamino-1-(4-morpholinophenyl)-1-butanone, 2,4,6-trimethylbenzoyl-diphenylphosphine oxide, 2-methyl-1-4(methylthio), phenyl-2-morpholino-1-propanone, bis(2,6-dimethoxybenzoyl)(2,4,4-trimethylpentyl)phosphine oxide, etc. The compounds may be used individually or in combination.

Examples of thermal initiators that may be employed generally include peroxides such as acetyl and benzoyl peroxides. Specific examples of thermal initiators that can be utilized include, but are not limited to, 4,4′-azobis(4-cyanovaleric acid), 1,1′-azobis(cyclohexanecarbonitrile), 2,2′-azobis(2-methylpropionitrile), benzoyl peroxide, 2,2-bis(tert-butylperoxy)butane, 2,5 -bis(tert-butylperoxy)-2,5-dimethylhexane, bis[1-(tert-butylperoxy)-1-methylethyl]benzene, tert-butyl hydroperoxide, tert-butyl peracetate, tert-butyl peroxide, tert-butyl peroxybenzoate, cumene hydroperoxide, dicumyl peroxide, lauroyl peroxide, peracetic acid, and, potassium persulfate. As examples, the photoinitiator may be α-hydroxyketone, phenylglyoxylate, benzildimethyl ketal, α-aminoketone, monoacylphosphine, bisacylphosphine, and mixtures thereof.

Cationically polymerizable materials include but are not limited to materials containing epoxy and vinyl ether functional groups and may be used herein. These systems are photo-initiated by onium salt initiators, such as triarylsulfonium, and diaryliodonium salts.

Materials also comprise a solvent. Any solvent in which the components of the material may be dissolved, dispersed, suspended or the like may be used. The solvent may be an organic compound that does not appreciably participate in the cross-linking reaction, if the material is to be cured, and which exists in a liquid phase at room temperature and 1 atmosphere. The viscosity and surface tension of the solvent are not specifically limited. Examples of suitable solvents include chloroform, acetonitrile, methylethylketone, ethylacetate, and mixtures thereof. Any amount of solvent capable of dissolving, dispersing, suspending, etc. the components of the material may be used. Preferably, a sufficient amount of solvent will be used so that the material can readily be disposed on a donor substrate. Generally, the amount of solvent will range from 60 to 90 wt %, e.g. 70 to 80 wt %, with respect to the total weight of the material.

In addition, at least a portion of the solvent should be actively or passively removable from the material during a flexographic printing process. A reduced solvent material is preferably a flowable material at room temperature or at temperatures at which flexographic printing processes are carried out.

### Methods

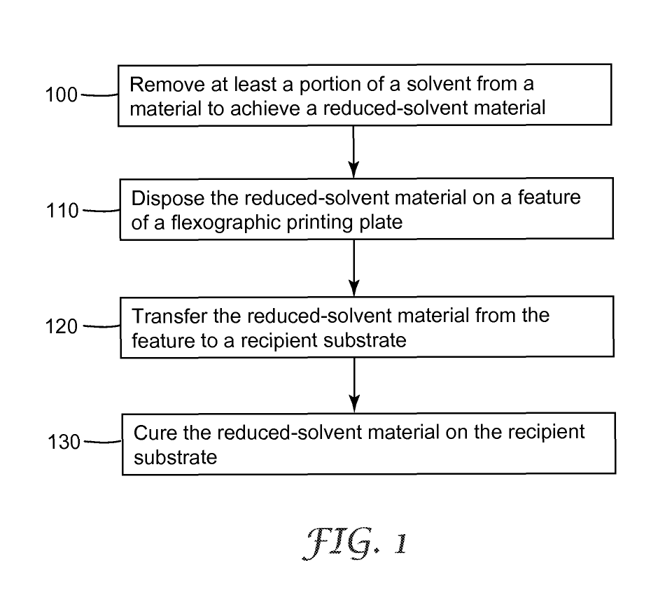

Exemplary methods for printing a material on a recipient substrate using flexographic printing techniques are described below. FIG. 1 provides an example of such a method. The method depicted in FIG. 1 comprises removing at least a portion of a solvent from a material to achieve a reduced-solvent material (100). The reduced-solvent material is then disposed on a feature of a flexographic printing plate (110). The method may further comprise transferring the reduced-solvent material from the feature of the printing plate to a recipient substrate (120). The method may also comprise curing the material on the recipient substrate (130).

Any known or future developed technique suitable for removing solvent from the material may be employed. In some circumstances it may be desirable to allow the solvent to passively evaporate to achieve a reduced solvent material. In other circumstances it may be appropriate to facilitate solvent evaporation through the use of a solvent removal apparatus, such as a microwave or infrared radiation apparatuses to assist in solvent evaporation or dryers.

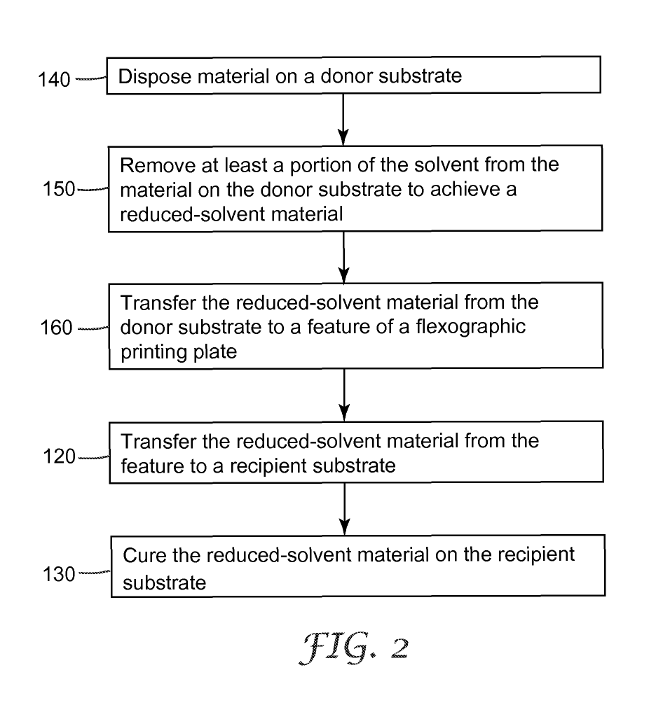

As shown in FIG. 2, the material may be disposed on a donor substrate (140) and at least a portion of the solvent may be removed while the material is on the donor substrate (150). Any known or future developed technique capable of disposing reliable amounts of material on the donor substrate may be used. Exemplary techniques include dip coating, die coating, and roll coating. As further shown in FIG. 2, the reduced solvent material may be disposed onto the feature of the printing plate (110, see FIG. 1) by transferring the reduced-solvent material from the donor substrate to the feature of the flexographic plate (160).

Any amount of solvent may be removed from material to achieve a reduced-solvent material. Preferably a sufficient amount of solvent is removed to enhance the uniformity of transfer of amounts of reduced-solvent material to the feature of the flexographic printing plate. In some cases removing at least 10% of the solvent may be sufficient. In other cases, removing at least 50%, 90%, 95%, 99%, or substantially all of the solvent may be desired. If the reduced-solvent material is to be cured soon after transfer from the feature to a recipient substrate, it will generally be desirable to remove more of the solvent prior to disposing the reduced-solvent material onto the feature than if the reduced-solvent material is to be cured at a time further removed from transfer to the recipient substrate. It will generally be desirable to remove substantially all of the solvent from the material, if the reduced-solvent material is to be cured while it is being transferred from the feature of the printing plate to the recipient substrate, e.g. as described in U.S. Provisional Patent Application Ser. No. 60/865,968, entitled “FLEXOGRAPHIC PRINTING WITH CURING DURING TRANSFER TO SUBSTRATE” to Mikhail Pekurovsky, filed on even date herewith, which application is incorporated herein by reference in its entirety to the extent it does not contradict the disclosure presented herein.

By varying the concentration of solvent in the material or the amount of solvent removed from the material, the thickness of the reduced-solvent material at the point of contact with the feature of the flexographic printing plate can be adjusted to give desirable amounts and placement of the material on the printing feature. For example, if the reduced-solvent material is disposed too thickly on the donor substrate at the point of contact with a feature of the printing plate, the feature may become overloaded and the width of printed material on the recipient substrate will be larger than the lateral dimension of the feature. If the reduced-solvent material is disposed too thinly on the donor substrate at the point of contact with a feature of the printing plate, the feature may not be sufficiently loaded and the quality of the printing may be compromised. The concentration of solvent and solvent removal can readily be adjusted to obtain a desired amount and placement of material on the printing features.

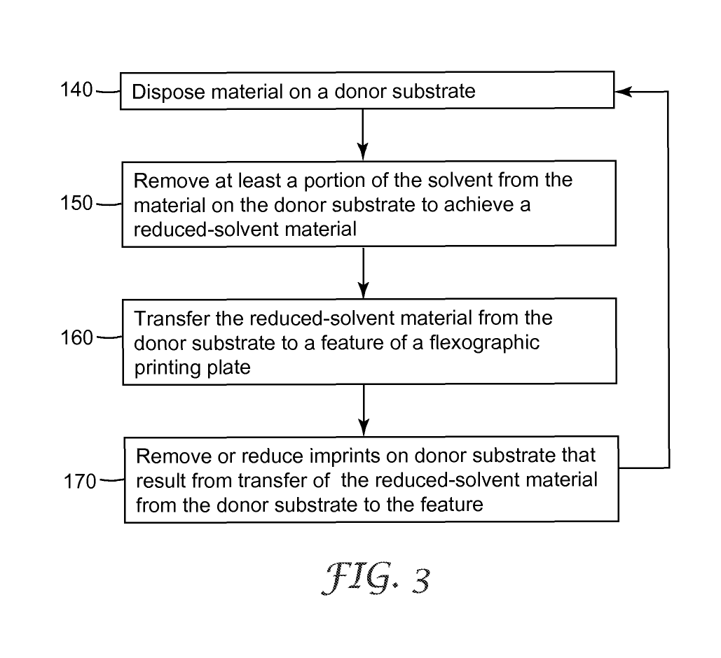

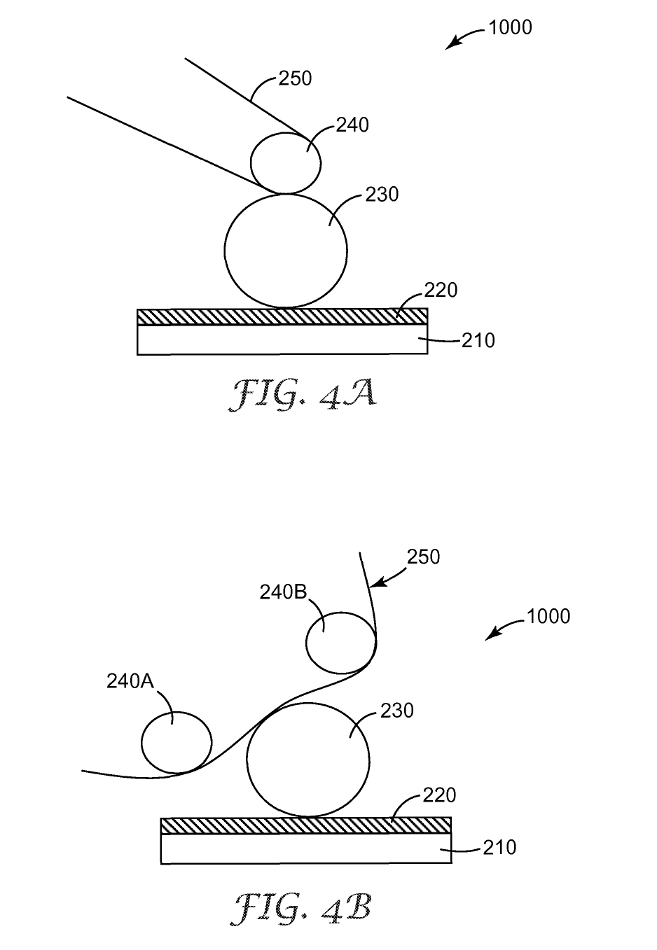

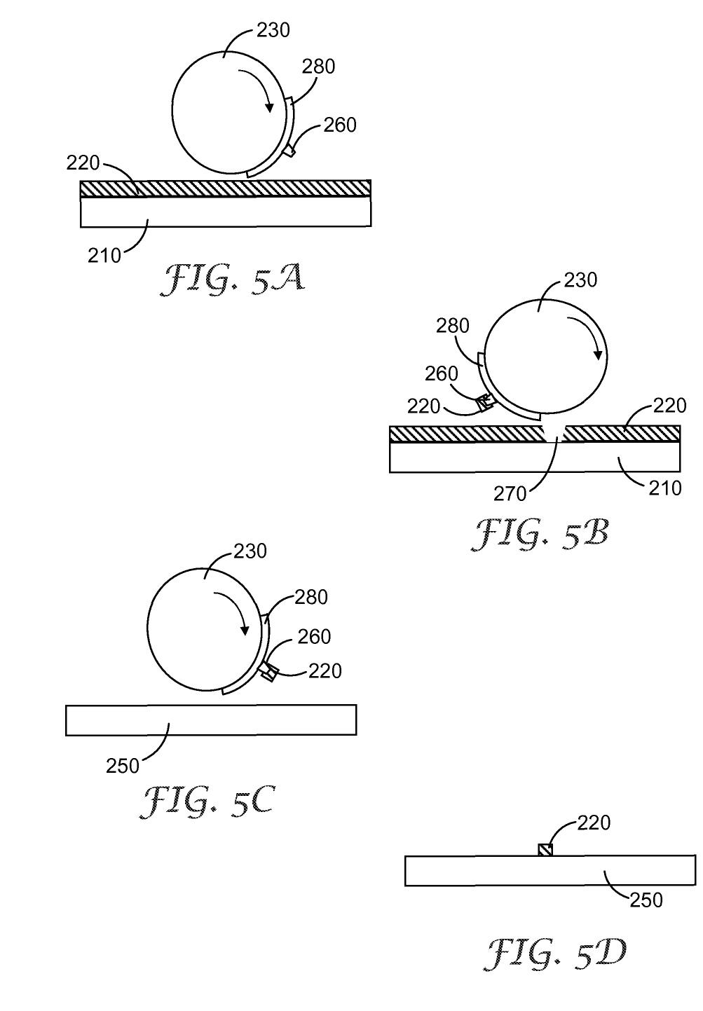

Referring to FIG. 3, a method for flexographic printing is illustrated where the donor substrate is rendered suitable for continuous transfer of material to a feature of a flexographic printing plate. The method comprises disposing material onto a donor substrate (140), removing at least a portion of the solvent from the material on the donor substrate to achieve a reduced-solvent material (150), and transferring the reduced-solvent material from the donor substrate to a feature of a flexographic printing plate (160). The method further comprises reducing or removing imprints (see e.g., FIGS. 4 and 5) on donor substrate that result from transfer of the reduced-solvent material from the donor substrate to the feature (170), rendering the donor substrate suitable for receiving material (140). Thus, the donor substrate can be recycled and used for continuous printing. Removal of imprints (170) and rendering the donor substrate suitable for receiving material (140) may be beneficial when the donor substrate is associated with a roll or cylinder, and may also be useful for plates or films not associated with a roll or cylinder. Of course, in some embodiments, it may be desirable to simply dispose of the donor substrate; e.g. where the donor substrate is a flat film or plate, rather than removing imprints.

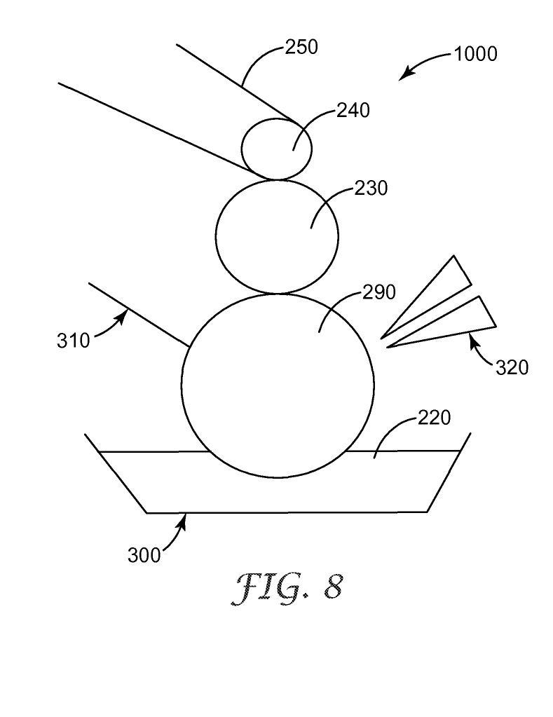

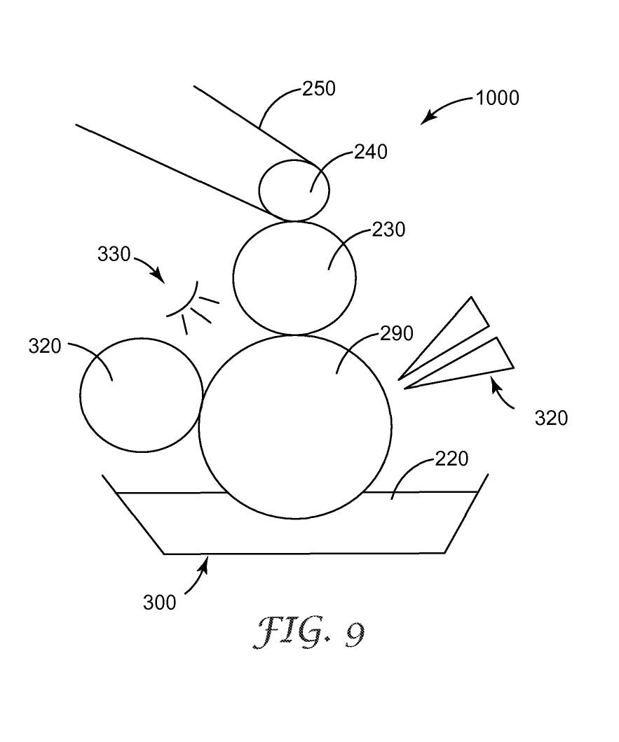

Generally, reducing or removing imprints from a donor substrate (170) will comprise removing all or substantially all of the untransferred reduced-solvent material from the donor substrate. Any known or future developed technique may be used to reduce or remove imprints or remove reduced-solvent material from the donor substrate. In an embodiment, a roll may be used to smooth the remaining material on the donor substrate as shown, e.g., in FIG. 9, to reduce or remove imprints. As further shown in FIG. 9, the remaining reduced-solvent material on the donor substrate may be cured and removed from donor substrate following transfer of reduced-substrate material to a feature of a flexographic printing plate. In another embodiment, a blade in contact with the donor substrate may be used to remove remaining reduced-solvent material from the donor substrate (see, e.g., FIG. 8).

It will be understood that various steps presented in FIGS. 1-3 may be intermixed, interchanged, combined, etc. as appropriate. For example, it is evident that the methods described in FIGS. 2 and 3 may be combined.

### Systems

The methods described above can be carried out with any suitable flexographic printing system. Exemplary flexographic systems and components thereof suitable for carrying out the methods described above are described below. In describing the exemplary systems, the term material 220 will be used for convenience in describing both material that comprises a fully saturated solution and a reduced solvent material. It should be understood that (i) material 220 when initially disposed onto a donor substrate will comprise a full concentration solvent, (ii) solvent will be removed, actively or passively, from material 220 prior to transfer to a feature of a flexographic printing plate, and (iii) material 220 transferred to the feature refers to reduced-solvent material 220.

Referring to FIG. 4, side views of systems 1000 for flexographic printing are illustrated. The system 1000 comprises a donor substrate 210 configured to receive material 220 to be printed on a recipient substrate 250. The system 1000 includes a flexographic roll 230 configured to attachably receive a flexographic printing plate 280 (see, e.g., FIG. 5). Flexographic printing plate 280 may be attached to flexographic roll 230 using any suitable technique. One suitable technique includes attaching flexographic plate 280 to flexographic roll 230 using an adhesive.

Flexographic roll 30 is moveable relative to the donor substrate 210 such that material 220 may be transferred from donor substrate 210 to a feature 260 (see, e.g., FIG. 5) of a flexographic printing plate 280. The system 1000 depicted in FIG. 4A further includes a backup roll 240 positioned relative to flexographic roll 230 such that movement of backup roll 240 relative to flexographic roll 230 is capable of causing recipient substrate 250 to move between flexographic roll 230 and backup roll 240, allowing material 220 to be transferred from feature 260 of printing plate 280 (see, e.g., FIG. 5). The system 1000 depicted in FIG. 4B includes two backup rolls 240A, 240B positioned relative to flexographic roll 230 such that movement of backup rolls 240A, 240B relative to flexographic roll 230 is capable of causing recipient substrate 250 to move between flexographic roll 230 and backup rolls 240A, 240B, allowing material 220 to be transferred from feature 260 of printing plate 280 (see, e.g., FIG. 5).

Flexographic roll 230 and backup roll 240, 240A, 240B depicted in FIG. 4 may be in the form of cylinders and the rolls 230, 240, 240A, 240B may rotate about the respective central axes of the cylinders. Such rotation allows printing plate 280 (not shown in FIG. 4) attached to flexographic roll 230 to contact material 220 and then transfer material 220 to recipient substrate 250. Such rotation also allows recipient substrate 250 to move between flexographic roll 230 and backup roll 240, 240A, 240B.

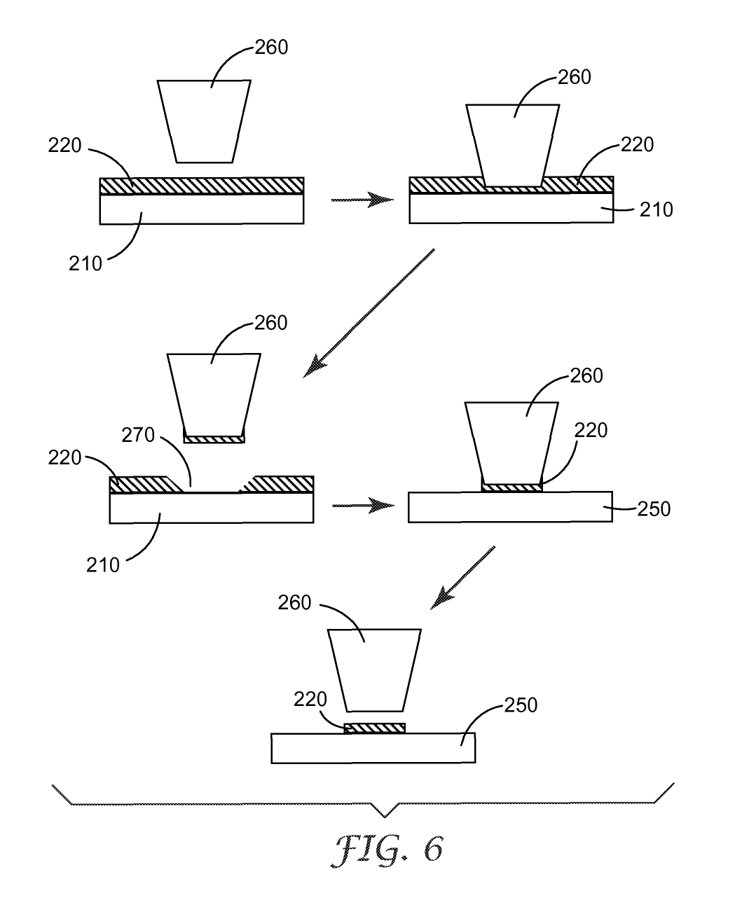

Referring to FIGS. 5 and 6, transfer of material 220 from donor substrate 210 to recipient substrate 250 by feature 260 of flexographic printing plate 280 is shown. In FIG. 5, printing plate 280 is shown attached to flexographic roll 230. As roll 230 rotates relative to donor substrate 210 and recipient substrate 250, material 220 is transferred from donor substrate 210 to feature 260 of flexographic plate 280 and from feature 280 to recipient substrate 250. FIG. 6 similarly shows transfer of material 220 from donor substrate 210 to feature 260 and from feature 280 to recipient substrate 250. As shown in FIGS. 5 and 6, imprints 270 on donor substrate 210 may result from the transfer of material 220 from donor substrate 210 to feature 260. While not shown, it will be understood that some material 220 may remain on feature 260 after transfer to recipient substrate 250.

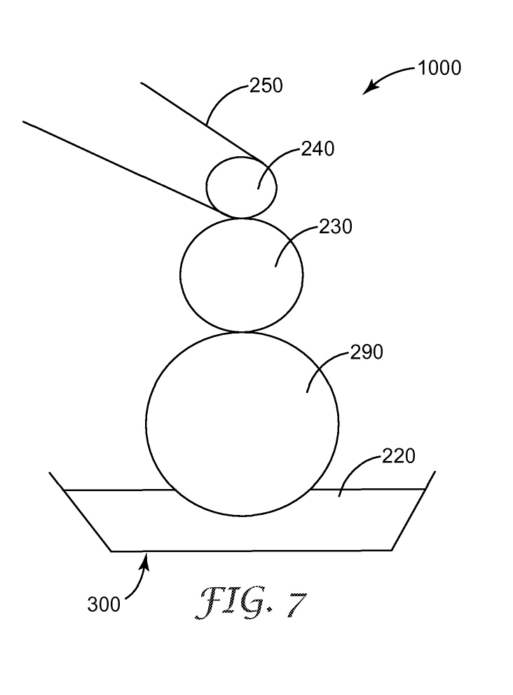

Referring to FIG. 7, a side view of another exemplary flexographic printing system 1000 is illustrated. The system 1000 includes an inking roll 290 in the form of a cylinder. A donor substrate 210 (not shown in FIG. 7) may be attached to inking roll 290. Alternatively, the outer surface of inking roll 290 may serve as donor substrate 210. In various embodiments where the surface inking roll 290 serves as donor substrate 210, the surface of the inking roll may be substantially smooth, which is in contrast to anilox rolls that comprise a surface built out of small cells.

The system 1000 depicted in FIG. 7 also includes a reservoir 300 for housing material 220. As inking roll 290 rotates about its central axis and relative to reservoir 300, material 220 is transferred to donor substrate 210. However, it will be understood that nearly any method may be used to dispose material 220 on inking roll 290, including, for example, die coating and roll coating. Flexographic roll 230, to which flexographic plate 280 (not show in FIG. 7) may be attached, rotates relative to inking roll 290 such that material 220 is transferred to feature 260 of flexographic printing plate 280. In the system 1000 described in FIG. 7, solvent is passively removed from material 220; e.g., through evaporation. That is, at some point, if not continuously, solvent is removed from material 220 as it is transferred from reservoir 300 as a high concentration solvent material 220 to feature 260 as a reduced-solvent material 220. As described with regard to FIG. 3, material 220 material may then be transferred from feature 260 of plate 280 to recipient substrate 250.

Referring to FIG. 8, a side view of another exemplary flexographic printing system 1000 is illustrated. FIG. 8 depicts a system 1000 having a solvent removal apparatus 320. Any apparatus capable of removing solvent from material 220 on donor substrate 210 associated with inking roll 290 may be employed. Examples of suitable solvent removal apparatuses 320 include microwave or infrared radiation apparatuses to assist in solvent evaporation or dryers. Also depicted in FIG. 8 is a doctor blade 310. Blade 310 is in contact with at least a portion of donor substrate 210, which is associated with inking roll 290. Blade 310 is capable of at least partially removing one or more imprints 270 from donor substrate 210. Of course it will be understood that any apparatus for removing or reducing imprints may be used.

For example FIG. 9 shows a system 1000 including a smoothing roll 320 in contact with or in close proximity to inking roll 290. Smoothing roll 320 is capable of reducing or removing imprints on the surface of the inking roll 290 (i.e., the donor substrate 210). Also depicted in FIG. 9 is an energy source 330 capable of curing material 220 on the inking roll 320 following transfer of material 220 from feature 260 of printing plate 280 to recipient substrate 250. The smoothing roll 320 may then be used to peel the cured material 220 from the surface of the inking roll 290.

Of course it will be understood that the components of the various systems 1000 discussed throughout this disclosure can be interchanged. For example, the system 1000 of FIG. 4 or FIG. 7 may include a solvent removal apparatus 320 or a blade 310 as depicted in FIG. 8. In addition, it will be understood that donor substrate 210, which is shown as a film or plate in FIGS. 4-6, may be in the form of a roll or attached to a roll, as depicted in FIGS. 7 and 8. It will also be understood that two backup rolls 240A, 240B as depicted in FIG. 4B may be substituted for the single backup roll 240 configuration shown in FIGS. 7-9.

### EXAMPLES

### Example 1

A micro-flexographic printing plate was prepared as described in U.S. Provisional Patent Application Ser. No. 60/865,979, entitled “SOLVENT-ASSISTED EMBOSSING OF FLEXOGRAPHIC PRINTING PLATES” to Mikhail Pekurovsky et al., filed on even date herewith. Briefly, the plate was prepared by taking a polymeric film having a micro-replicated linear prismatic structure (BEF 90/50, commercially available from 3M Co.), referred to as BEF master, depositing a thin layer of methyl ethyl ketone on its structured surface, and then positioning a CYREL® flexographic plate (type TDR B 6.35 mm thick, with removed coversheet, commercially available from DuPont Co.) on the top of the microreplicated surface. After 15 hours, the CYREL® plate was exposed to UV radiation through the attached micro-replicated film in a UV processor equipped with a mercury Fusion UV curing lamp (model MC-6RQN, Rockville, Md., 200 watt/in), run at approximately 5 fpm. The micro-replicated flexographic printing plate was then detached from the BEF master.

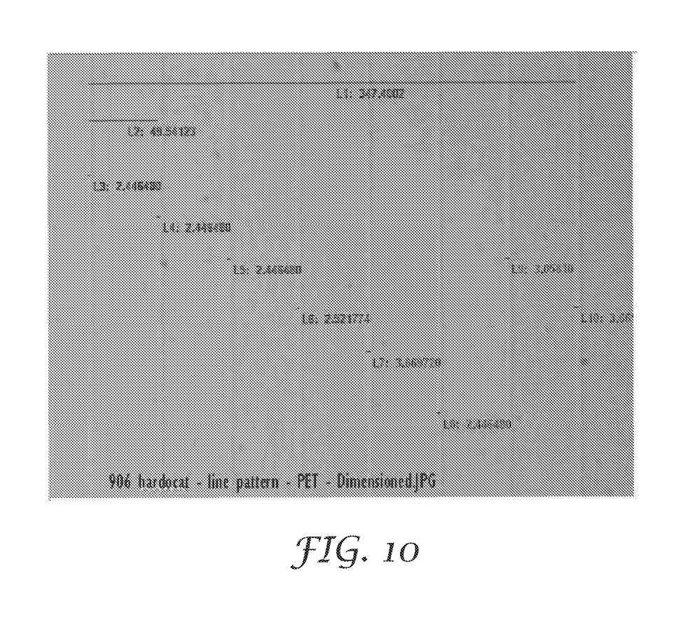

The microreplicated flexographic printing plate was then attached to a 12.7 cm-diameter glass cylinder by flexographic mounting tape (type 1120, commercially available from 3M Co.). A thin layer of type 906 hardcoat (33 wt % solids ceramer hardcoat dispersion containing 32 wt % 20 nm SiO₂ nano-particles, 8 wt % N,N-dimethyl acrylamid, 8 wt % methacryloxypropyl trimethoxysilane and 52 wt % pentaerythritol tri/tetra acrylate (PETA) in isopropylalcohol (IPA), 3M Co., St. Paul, Minn.) was deposited onto a clean glass slide by dip coating at 0.03 meters per minute from the 906 hardcoat solution in IPA (25 wt % solids), and then drying the glass slide in open air. The flexographic printing plate was then rolled by hand in the layer of hardcoat and then rolled onto a clean 125 micrometer-thick PET poly(ethylene terephtalate) film (available from DuPont Co). The printed PET film was then sent through a UV processor equipped with a mercury Fusion UV curing lamp (model MC-6RQN, Rockville, Md., 200 watt/in, nitrogen purged to 50 ppm O2 content), run at approximately 1.5 meters/min. Lines that were exposed to the UV light were cured and had a width of approximately 2.5 micrometers and were spaced approximately 50 micrometers apart forming a parallel line pattern illustrated with the micrographic image of FIG. 10.

### Example 2

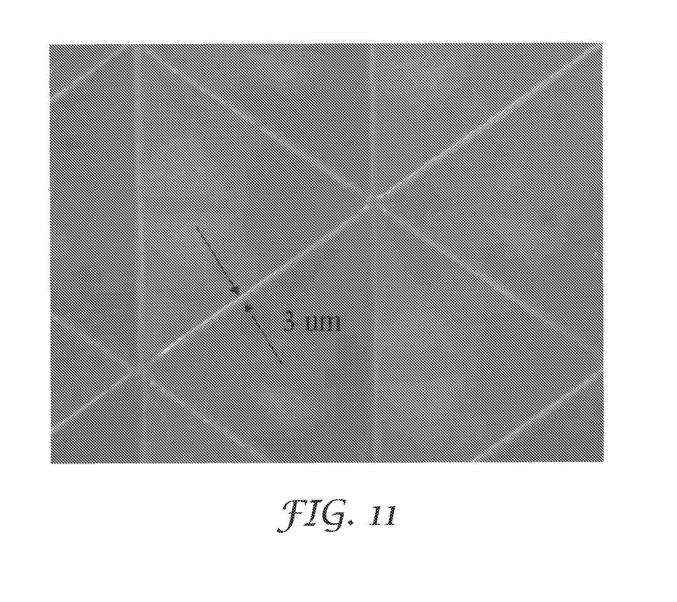

A micro-flexographic printing plate was prepared as described in U.S. Provisional Patent Application Ser. No. 60/865,979, entitled “SOLVENT-ASSISTED EMBOSSING OF FLEXOGRAPHIC PRINTING PLATES” to Mikhail Pekurovsky et al., filed on even date herewith. Briefly, the plate was prepared by taking a polymeric film with a micro-replicated cube-corner structure, depositing a small amount of methyl ethyl ketone on the master tool structured surface, and then positioning a CYREL® flexographic plate (type TDR B 6.35 mm thick, with removed cover sheet, available from DuPont Co.) on the top of the master tool microreplicated surface. After 15 hours, the CYREL® plate was exposed to UV radiation through attached microreplicated film in a UV processor (Fusion UV Curing lamp, model MC-6RQN, Rockville, Md., 200 watt/in, mercury lamp, run at approximately 1.5 meters per second) and then the microreplicated flexographic printing plate was detached from the master tool. This microreplicated flexographic printing plate was then attached to a 12.7 cm-diameter glass cylinder by flexographic mounting tape (type 1120, commercially available from 3M Co.). A micrographic image of this microreplicated flexographic printing plate illustrating the features is shown in FIG. 11.

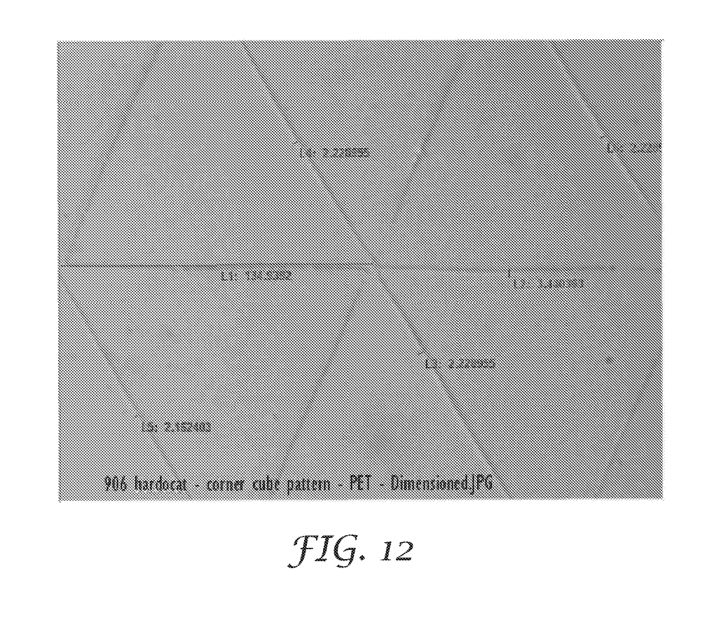

A thin layer of 906 hardcoat (described in Example 1) was deposited onto a clean glass slide by dip coating at 0.03 meters per minute from a 906 hardcoat solution in IPA (25 wt % solids), and drying that glass slide in open air. The flexographic printing plate was then rolled by hand in that layer of hardcoat and then rolled onto a clean 125 micrometer PET i.e., poly(ethylene terephtalate) film (available from DuPont Co). This PET film with printed lines was sent through a UV processor (Fusion UV Curing lamp, model MC-6RQN, Rockville, Md., 200 watt/inch, mercury lamp, purged by nitrogen to approximately 50 ppm of oxygen, run at approximately 1.5 meter per minute). The resulting printed lines were approximately 3 micrometers wide and 135 micrometers long forming a triangular pattern as illustrated in the micrographic image shown in FIG. 12.

Thus, embodiments of SOLVENT REMOVAL ASSISTED MATERIAL TRANSFER FOR FLEXOGRAPHIC PRINTING are disclosed. One skilled in the art will appreciate that embodiments other than those disclosed are envisioned. The disclosed embodiments are presented for purposes of illustration and not limitation, and the present invention is limited only by the claims that follow.

What is claimed is:

1. A method for flexographic printing, comprising:
removing at least a portion of a solvent from a material to achieve a reduced-solvent material;
disposing the reduced-solvent material onto a feature of a flexographic printing plate; and
transferring the reduced solvent material from the feature to a recipient substrate.

2. A method according to claim 1, further comprising curing the reduced-solvent material on the recipient substrate.

3. A method according to claim 1, further comprising disposing the material onto a donor substrate, wherein removing at least a portion of the solvent from the material occurs while the material is disposed on the donor substrate.

4. A method according to claim 3, wherein disposing the reduced solvent material onto the feature of the flexographic printing plate comprises transferring the reduced solvent material from the donor substrate to the feature.

5. A method according to claim 3, wherein disposing the material onto the donor substrate comprises die coating the donor substrate with the material.

6. A method according to claim 1, wherein removing at least a portion of the solvent from the material comprises removing at least 10% of the solvent from the material.

7. A method according to claim 1, wherein removing at least a portion of the solvent from the material comprises removing at least 90% of the solvent from the material.

8. A method according to claim 1, wherein removing at least a portion of the solvent from the material comprises removing substantially all of the solvent from the material.

9. A method according to claim 1, wherein the feature comprises a lateral dimension of 15 micrometers or less.

10. A method according to claim 1, wherein the feature comprises a lateral dimension of 10 micrometers or less.

11. A method for flexographic printing, comprising:
(a) disposing onto a donor substrate a material comprising a solvent;
(b) removing at least a portion of the solvent from the material on the donor substrate to achieve a reduced-solvent material;
(c) transferring the reduced-solvent material from the donor substrate to a feature of a flexographic printing plate;
(d) transferring the reduced-solvent material from the feature to a recipient substrate; and
(e) reducing or removing an imprint on the donor substrate that results from transfer of the reduced-solvent material from the donor substrate to the feature of the flexographic printing plate.

12. A method according to claim 11, wherein reducing imprints on the donor substrate comprises removing untransferred reduced-solvent material from the donor substrate to achieve a donor substrate suitable for receiving the material comprising solvent.

13. A method according to claim 12, further comprising repeating steps (a)-(e), wherein the donor substrate is the donor substrate suitable for receiving the material comprising solvent.

14. A method according to claim 11, further comprising curing the reduced-solvent material on the recipient substrate.

15. A flexographic printing system, comprising:
a donor substrate configured to receive a material comprising a solvent such that the material is disposed on the donor substrate;
a solvent removal apparatus capable of removing the solvent from the material disposed on the donor substrate to produce a reduced-solvent material disposed on the donor substrate;
a flexographic roll configured to attachably receive a flexographic printing plate comprising a feature, the flexographic roll moveable relative to the donor substrate to allow the reduced-solvent material on the donor substrate to be transferred to the feature of the printing plate; and
a backup roll positioned relative to the flexographic roll such that movement of the backup roll relative to the flexographic roll is capable of causing a recipient substrate to move between the backup roll and the flexographic roll to allow the reduced-solvent substrate to be transferred from the feature to the recipient substrate.

16. A flexographic printing system according to claim 15, wherein the donor substrate is associated with an inking roll.

17. A flexographic printing apparatus system to claim 15, further comprising an apparatus for removing imprints in the donor substrate that result from transfer of the reduced solvent material from the donor substrate to the feature.

18. A flexographic printing system according to claim 15, further comprising the flexographic printing plate.

19. A flexographic printing system according to claim 18, wherein the flexographic printing plate comprises a feature comprising a lateral dimension of 15 micrometers or less.

20. A flexographic printing system according to claim 15, wherein the donor substrate comprises a substantially smooth surface onto which the material is disposed.
